(19) United States
(12) Patent Application Publication
(10) Pub. No.: US 2021/0122157 A1
(43) Pub. Date: Apr. 29, 2021

(54) INKJET HEAD AND INKJET RECORDING APPARATUS

(71) Applicant: TOSHIBA TEC KABUSHIKI KAISHA, Tokyo (JP)

(72) Inventor: Masaya ICHIKAWA, Sunto Shizuoka (JP)

(21) Appl. No.: 16/927,752

(22) Filed: Jul. 13, 2020

(30) Foreign Application Priority Data
Oct. 25, 2019 (JP) 2019-194464

(51) Int. Cl. B41J 2/045

(52) U.S. Cl. CPC B41J 2/04596; B41J 2202/10; B41J 2/04581; B41J 2/04573

(57) ABSTRACT

According to one or more embodiment, an inkjet head comprises an actuator and a controller. The actuator is configured to expand and contract a pressure chamber filled with a liquid or the like. The controller is configured to apply a discharge pulse to the actuator, the discharge pulse comprising an expansion pulse for expanding the pressure chamber, a first contraction pulse with a first peak value for contracting the pressure chamber, a pause period, and a second contraction pulse with a second peak value that is higher than the first peak value for further contracting the pressure chamber.

### CROSS-REFERENCE TO RELATED APPLICATIONS

This application is based upon and claims the benefit of priority from Japanese Patent Application No. 2019-194464, filed on Oct. 25, 2019, the entire contents of which are incorporated herein by reference.

### FIELD

Embodiments described herein relate generally to an inkjet head and an inkjet recording apparatus.

### BACKGROUND

Some inkjet heads discharge ink droplets from a pressure chamber. The pressure chamber comprises an actuator. Such an inkjet head applies a discharge pulse to the actuator for driving the pressure chamber.

Such an inkjet head changes a driving voltage of the discharge pulse in order to vary a volume of the ink droplets; however, the ink droplets cannot be discharged at all if the driving voltage is reduced to be less than some predetermined voltage level.

This limits the minimum volume of the ink droplets to be discharged. There is a need for an inkjet head and an inkjet recording apparatus capable of effectively discharging liquid droplets having less volume.

### BRIEF DESCRIPTION OF THE DRAWINGS

FIG. 1 depicts a configuration of an inkjet recording apparatus according to a first embodiment.

FIG. 2 depicts an inkjet head in a perspective view according to a first embodiment.

FIG. 3 depicts an inkjet head in an exploded perspective view according to a first embodiment.

FIG. 4 depicts an inkjet head in a cross-sectional view taken along line F-F in FIG. 2 according to a first embodiment.

FIG. 5 depicts a configuration of a control system of an inkjet recording apparatus according to a first embodiment.

FIG. 6 depicts an operation example of an inkjet head according to a first embodiment.

FIG. 7 depicts an example of a drive waveform applied to an actuator according to a first embodiment.

FIG. 8 depicts an example of a drive waveform applied to an actuator according to a second embodiment.

FIG. 9 depicts an example of a width of a pause period and a width of a second contraction pulse according to a second embodiment.

### DETAILED DESCRIPTION

According to one or more embodiment, an inkjet head comprises an actuator and a controller. The actuator is configured to expand and contract a pressure chamber that can be filled with a liquid, such as an ink or the like. The controller is configured to apply a discharge pulse to the actuator, the discharge pulse comprising an expansion pulse for expanding the pressure chamber, a first contraction pulse with a first peak value for contracting the pressure chamber, a pause period, and a second contraction pulse with a second peak value that is higher than the first peak value for further contracting the pressure chamber.

Hereinafter, an inkjet recording apparatus according to an embodiment will be described with reference to the drawings.

### First Embodiment

An inkjet recording apparatus according to the first embodiment forms an image on a medium such as a sheet of paper by using an inkjet head. The inkjet recording apparatus discharges ink droplets contained in a pressure chamber of an inkjet head onto a medium and forms an image on the medium. The inkjet recording apparatus is, for example, an office inkjet recording apparatus, a barcode inkjet recording apparatus, an inkjet recording apparatus for POS, an industrial inkjet recording apparatus, a 3D inkjet recording apparatus, or the like. The medium on which an image is formed is not limited to any specific configuration. An inkjet head included in a printer according to one embodiment is an example of a liquid discharging head, and ink is an example of a liquid to be discharged from the liquid discharging head.

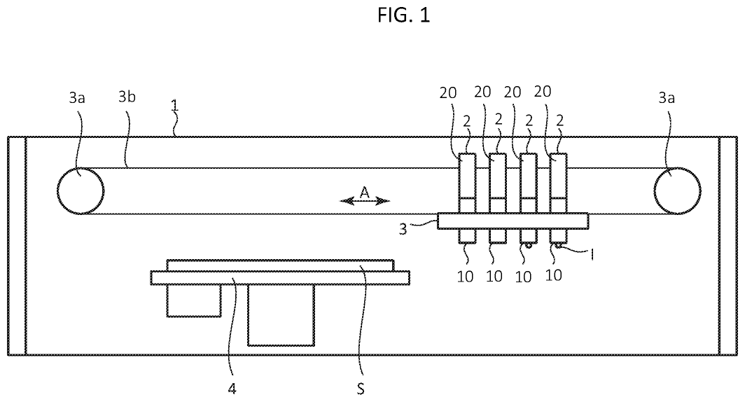

FIG. 1 is a schematic view illustrating an example of the configuration of the inkjet recording apparatus 1 according to the first embodiment.

The inkjet recording apparatus 1 forms an image on a medium S or the like by using a recording material such as ink. The inkjet recording apparatus 1 comprises, for example, a plurality of liquid discharge units 2, a head support mechanism 3 that movably supports the liquid discharge units 2, and a media support mechanism 4 (may also be referred to as a supporting unit) that movably supports the medium S. The medium S is, for example, a sheet made of paper, a cloth, a resin, or the like.

As shown in FIG. 1, the plurality of liquid discharge units 2 are supported by the head support mechanism 3 in a state in which they are arranged in parallel in a predetermined direction. The head support mechanism 3 is attached to an endless belt 3b hung on rollers 3a. The inkjet recording apparatus 1 moves the rollers 3a in a main scanning direction A perpendicular to a conveyance direction of the medium S by rotating the rollers 3a. The liquid discharge unit 2 integrally includes an inkjet head 10 and a circulation device 20. The liquid discharge unit 2 performs a discharging operation for discharging or ejecting, for example, ink I as a liquid from the inkjet head 10.

In one embodiment, the inkjet recording apparatus 1 may be a scanning system that performs an ink discharge operation while moving the head support mechanism 3 back and forth in the main scanning direction A, thereby forming a desired image on the medium S that is disposed to face the inkjet recording apparatus 1.

In another embodiment, the inkjet recording apparatus 1 may be a single pass system in which the ink discharge operation is performed without moving the head support mechanism 3. In such a single pass system, it is not necessary to provide the rollers 3a and the endless belt 3b, and the head support mechanism 3 is fixed to, for example, a housing of the inkjet recording apparatus 1.

The plurality of liquid discharge units 2 discharge inks of four colors corresponding to CMYK (cyan, magenta, yellow, and black), that is, cyan ink, magenta ink, yellow ink, and black ink, respectively.

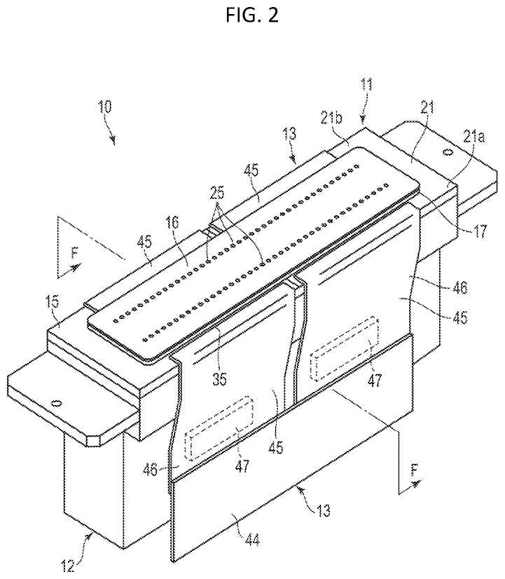

Hereinafter, the inkjet head 10 will be described with reference to FIGS. 2 to 4 according to the first embodiment. As the inkjet head 10, a side-shooter type inkjet head of a circulation type utilizing a shared wall system or method is illustrated in each drawing. In other embodiments, the inkjet head 10 may be an inkjet head of other types.

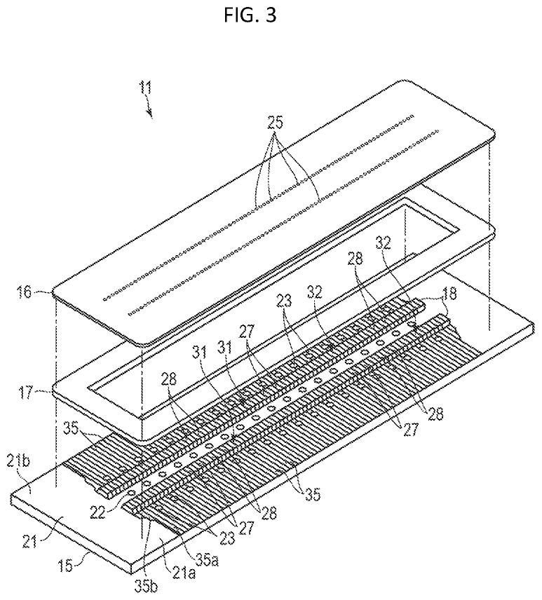

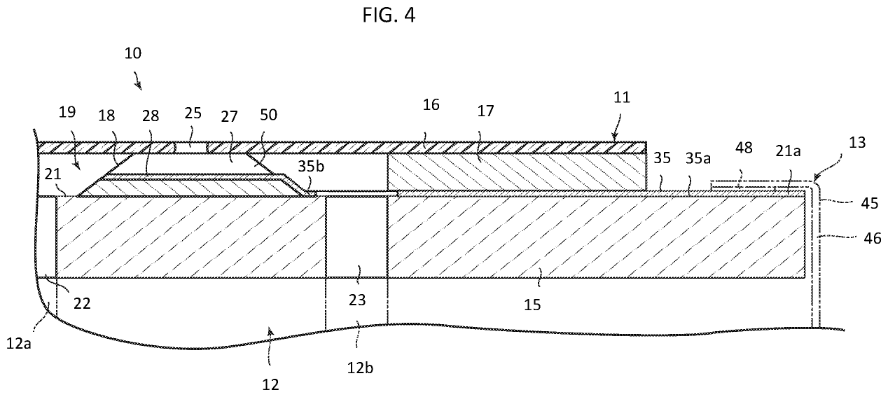

FIG. 2 is a perspective view illustrating an example of a configuration of the inkjet head 10. FIG. 3 is an exploded perspective view illustrating an example of a configuration of the inkjet head 10. FIG. 4 is a cross-sectional view taken along line F-F of FIG. 2.

The inkjet head 10 is equipped in the inkjet recording apparatus 1 and connected to an ink tank via a component such as a tube. The inkjet head 10 comprises a head main body 11, a unit portion 12, and a pair of circuit boards 13. The inkjet head 10 is an example of a waveform generation device.

The head main body 11 is a device for discharging ink. The head main body 11 is attached to the unit portion 12. The unit portion 12 includes a manifold that forms a portion of a path between the head main body 11 and the ink tank, and a member for attaching the unit portion 12 to the inside of the inkjet recording apparatus 1. The pair of circuit boards 13 are attached to the head main body 11.

As shown in FIGS. 3 and 4, the head main body 11 comprises a base plate 15, a nozzle plate 16, a frame member 17, and a pair of driving elements 18. As shown in FIG. 4, an ink chamber 19 to be supplied with ink is formed inside the head main body 11.

As shown in FIG. 3, the base plate 15 is formed into a rectangular plate shape by a ceramic such as alumina, for example. The base plate 15 has a flat mounting surface 21. In the base plate 15, a plurality of supply ports 22 and a plurality of drainage ports 23 are opened on the mounting surface 21.

The supply ports 22 are arranged in the central portion of the base plate 15 in a longitudinal direction of the base plate 15. The respective supply ports 22 communicate with ink supply portions 12a (see FIG. 4) of the manifold of the unit portion 12. The supply ports 22 are connected to the ink tank in the circulation device 20 via the ink supply portions 12a. The ink in the ink tank is supplied to the ink chamber 19 through the ink supply portions 12a and the supply ports 22.

The drainage ports 23 are arranged side by side in two rows so as to sandwich the supply ports 22. The respective drainage ports 23 communicate with ink drainage portions 12b (see FIG. 4) of the manifold of the unit portion 12. The drainage ports 23 are connected to the ink tank in the circulation device 20 via the ink discharge portions 12b. The ink in the ink chamber 19 is collected in the ink tank through the ink drainage portions 12b and the drainage ports 23. As described above, the ink circulates between the ink tank and the ink chamber 19.

The nozzle plate 16 is formed of, for example, a rectangular film made of polyimide and having a liquid-repellent function on its surface. The nozzle plate 16 is positioned opposite to the mounting surface 21 of the base plate 15. A plurality of nozzles 25 are arranged in two rows along the longitudinal direction of the nozzle plate 16.

The frame member 17 is formed in a rectangular frame shape of, for example, a nickel alloy. The frame member 17 is interposed between the mounting surface 21 of the base plate 15 and the nozzle plate 16. The frame member 17 is adhered to the mounting surface 21 and the nozzle plate 16. In other words, the nozzle plate 16 is attached to the base plate 15 via the frame member 17. As shown in FIG. 4, the ink chamber 19 is surrounded by the base plate 15, the nozzle plate 16, and the frame member 17.

The driving elements 18 comprise, for example, two plate-shaped piezoelectric bodies formed of lead zirconate titanate (PZT). The two piezoelectric bodies are bonded to each other such that the polarization directions thereof are opposite to each other in a thickness direction thereof.

As shown in FIG. 3, the pair of driving elements 18 are bonded to the mounting surface 21 of the base plate 15. As shown in FIG. 4, the pair of driving elements 18 are arranged in parallel with each other in the ink chamber 19 and positioned corresponding to the nozzles 25 of the nozzle plate arranged in two rows. Each driving element 18 is formed in a trapezoidal cross-sectional shape. The top of the driving element 18 is glued to the nozzle plate 16.

A plurality of grooves 27 are provided in the driving elements 18. The grooves 27 extend in a direction intersecting the longitudinal direction of the driving elements 18 and are arranged in the longitudinal direction of the driving elements 18. The plurality of grooves 27 are positioned opposite to the plurality of nozzles 25 of the nozzle plate 16. As shown in FIG. 4, in the driving elements 18 according to the present embodiment, a plurality of pressure chambers 50 for filling ink are arranged in the grooves 27.

An electrode 28 is provided in each of the plurality of grooves 27. The electrode 28 is formed by, for example, subjecting a nickel thin film to a photoresist etching process. The electrode 28 covers an inner surface of the groove 27.

As shown in FIG. 3, a plurality of wiring patterns 35 are provided across the driving elements 18 from the mounting surface 21 of the base plate 15. The wiring patterns 35 are formed by, for example, subjecting a nickel thin film to a photoresist etching process.

The wiring patterns 35 extend from both one side-end portion 21a and another side-end portion 21b of the mounting surface 21. The side-end portions 21a and 21b include not only an edge of the mounting surface 21 but also a peripheral region thereof. The wiring patterns 35 may thus be provided on the inner side of the edge of the mounting surface 21.

Hereinafter, the wiring patterns 35 extending from one side-end portion 21a will be described as a representative example. A basic configuration of the wiring patterns 35 of the side-end portion 21b is the same as that of the wiring patterns 35 of the side-end portion 21a.

As shown in FIGS. 3 and 4, each wiring pattern 35 has a first portion 35a and a second portion 35b. The first portion 35a extends linearly from the side-end portion 21a toward the driving element 18. The first portions 35a of the respective wiring patterns 35 extend parallel to each other. The second portion 35b of each wiring pattern 35 extends over the end portion of the first portion 35a and the electrode 28. The second portion 35b is electrically connected to the electrodes 28.

In one driving element 18, some (a subset) of the electrodes 28 of the plurality of electrodes 28 constitute a first electrode group 31. Some (a subset) of the other electrodes of the plurality of electrodes 28 constitute a second electrode group 32.

The first electrode group 31 and the second electrode group 32 are divided by a central portion in the longitudinal direction of the driving element 18 as a boundary. The second electrode group 32 is adjacent to the first electrode group 31. Each of the first and second electrode groups 31 and 32 include, for example, one-hundred fifty-nine (159) electrodes 28.

As shown in FIG. 2, each of the pair of circuit boards 13 has a substrate main body 44 and a pair of film carrier packages (FCP) 45. Note that FCP can also be referred to as a tape carrier package (TCP) in some contexts.

The substrate main body 44 is a printed wiring board having a rigid shape that is lacks substantially flexibility. Various electronic components and connectors are mounted on the substrate main body 44. The pair of FCP 45 are attached to the substrate main body 44.

Each of the pair of FCP 45 has a resin film 46 formed of a resin with flexibility and also has a head drive circuit 47 connected to the plurality of wirings. The film 46 may be tape automated bonding (TAB). The head drive circuit 47 may comprise an integrated circuit (IC) for applying a voltage to the electrodes 28. The head drive circuit 47 may be fixed to the film 46 by a resin.

One end portion of the FCP 45 is thermally coupled to the first portions 35a of the wiring patterns 35 by an anisotropic conductive film (ACF) 48 (see FIG. 4). The plurality of wirings of the FCP 45 are electrically connected to the wiring patterns 35.

When FCP 45 is connected to the wiring patterns 35, the head drive circuit 47 is electrically connected to the electrodes 28 via the wirings of the FCP 45. The head drive circuit 47 applies a voltage to the respective electrodes 28 via the wirings of the resin film 46.

When the head drive circuit 47 applies a voltage to the electrodes 28, the corresponding driving elements 18 undergo shear mode deformation, and a volume of the pressure chamber 50 (see FIG. 4) in which the electrodes 28 are provided is increased or decreased. As a result, the pressure of the ink in the pressure chamber 50 is changed, and the ink is discharged from a nozzle 25 (or nozzles 25). As described above, each of the driving elements 18 that separates the neighboring pressure chambers 50 from each other and serves as an actuator for making pressure changes to the inside of the pressure chamber 50.

The plurality of circulation devices 20 illustrated in FIG. 1 are integrally connected to an upper portion of the inkjet head 10 by a coupling component such as a metal member. Each circulation device 20 has a predetermined circulation path, along which the liquid circulates from the ink tank to the inkjet head 10 then back. Each circulation device 20 includes a pump for circulating a liquid. The liquid is supplied from the circulation device 20 to the inside of the inkjet head 10 through an ink supply unit by the action of the pump, the liquid then passes through the predetermined circulation path, and then is sent back from the inside of the inkjet head 10 to the circulation device 20 through an ink drainage unit.

In one embodiment, the circulation device 20 supplies the liquid to the circulation path from a cartridge, serving as a supply tank, provided outside the circulation path.

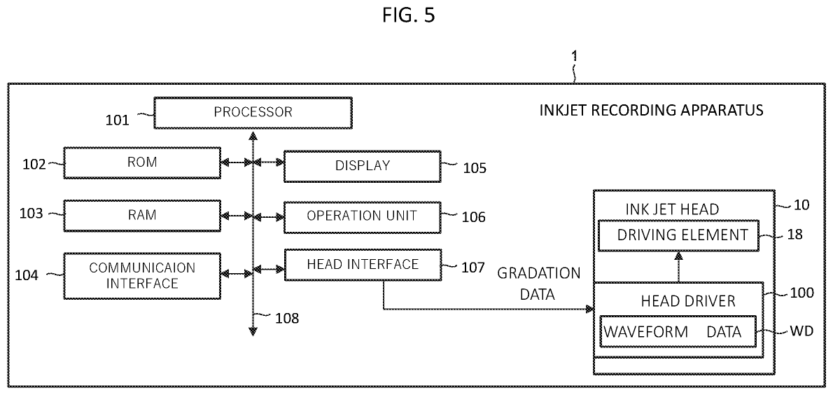

A configuration of the inkjet recording apparatus 1 will be described with reference to FIG. 5. FIG. 5 is a block diagram illustrating an example of aspects of a hardware configuration of the inkjet recording apparatus 1 according to the embodiment.

The inkjet recording apparatus 1 comprises a processor 101, a ROM 102, a RAM 103, a communication interface 104, a display unit 105, an operation unit 106, a head interface 107, a bus 108, and an inkjet head 10.

The processor 101 corresponds to a central portion of a computer that performs processing and control necessary for the operation of the inkjet recording apparatus 1. The processor 101 controls the respective units to realize various functions of the inkjet recording apparatus 1 based on a control program and/or various other programs. These programs may be provided as system software, application software, firmware, or the like stored in the ROM 102. The processor 101 is, for example, a central processing unit (CPU), a micro processing unit (MPU), a system on a chip (SoC), a digital signal processor (DSP), a graphics processing unit (GPU), or the like. Alternatively, the processor 101 is a combination of these.

The ROM 102 is a non-volatile memory used exclusively for reading data, which corresponds to a main storage part of a computer having the processor 101 as a central part. The ROM 102 stores the above-described programs. The ROM 102 also stores data, various setting values, and the like used by the processor 101 to perform various types of processing.

The RAM 103 is a memory used for reading and writing data corresponding to a main storage part of a computer having the processor 101 as a central part. The RAM 103 is used as a so-called work area or the like for storing data to be temporarily used by the processor 101 for performing various types of processing.

The communication interface 104 is an interface for the inkjet recording apparatus 1 to communicate with a host computer or the like via a network, a communication cable, or the like.

The display unit 105 displays a screen for notifying an operator (user) of the inkjet recording apparatus 1 of various kinds of information. The display unit 105 is, for example, a display such as a liquid crystal display or an organic EL (electro-luminescence) display.

The operation unit 106 receives an input operation performed by an operator of the inkjet recording apparatus 1. The operation unit 106 is, for example, a keyboard, a keypad, a touch pad, a mouse, or the like. In one embodiment, a touch pad disposed on the display panel of the display unit 105 may be used as the operation unit 106. A display panel included in a touch panel can be used as the display unit 105, and a touch pad included in the touch panel can be used as the operation unit 106.

The head interface 107 is provided for the processor 101 to communicate with the inkjet head 10. The head interface 107 transmits tone data (image/pixel gradation information) and the like to the inkjet head 10 under the control of the processor 101.

The bus 108 includes a control bus, an address bus, a data bus, and the like and transmits signals sent by or to the respective units of the inkjet recording apparatus 1.

The inkjet head 10 comprises a head driver 100.

The head driver 100 (or a control unit) is a drive circuit for operating the inkjet head 10. The head driver 100 comprises a head drive circuit 47 and the like. The head driver 100 is, for example, a line driver. The head driver 100 stores waveform data WD.

The head driver 100 generates a single drive signal based on the waveform data WD in a repetitive manner. Then, based on the gradation data, the head driver 100 controls the number of times the droplets are discharged to respective pixels being formed on the medium S. For each application of the single drive signal, one ink droplet (that is, a main or primary droplet) is discharged from the nozzle 25. The inkjet recording apparatus 1 may express shade/gradation of an image or the like based on the number of main droplets of ink discharged to the respective pixels. For example, the more droplets of ink that are discharged to one pixel, the greater (higher) the color density of a corresponding color of that pixel. That is, the pixel can be said to become darker with each additional droplet.

The head driver 100 is an example of a waveform generation device. The head driver 100 operates as a generator by generating a drive signal.

In one embodiment, the head driver 100 may have the waveform data WD already stored therein when it is provided to an administrator or end user of the head driver 100 (for example, a person who is responsible for utilization of the head driver 100).

In another embodiment, the head driver 100 may need to obtain and then store the wave form data WD at a later time. In still another embodiment, the head driver 100 may have different waveform data stored therein when it is provided to an administrator or the like and this different waveform data may be updated and/or overwritten.

There may be a further case where the waveform data WD is separately given to an administrator or the like and this data is written to the head driver 100 by an operation of the administrator or a service person. Such waveform data WD may be, for example, recorded in a removable storage medium such as a magnetic disk, a magneto-optical disk, an optical disk, or a semiconductor memory, or downloaded via a network or the like.

When the drive signal is applied, each of the driving elements 18, which is a piezoelectric body, is subjected to share-mode deformation. This deformation changes the volume of the pressure chamber 50.

In the present embodiment, the pressure chamber 50 is in a normal state when a potential of the drive signal is 0 (0 volts). When the potential of the drive signal is positive, the pressure chamber 50 contracts and the volume decreases, as compared to that of the normal state. When the potential of the drive signal is negative, the pressure chamber 50 expands and the volume increases as compared to that of the normal state. The pressure of the ink in the pressure chamber 50 changes with the change in the volume of the pressure chamber 50 as described above. The inkjet head 10 discharges the ink by applying a drive signal having a specific waveform. The waveform of the drive signal may be referred to as a drive waveform herein.

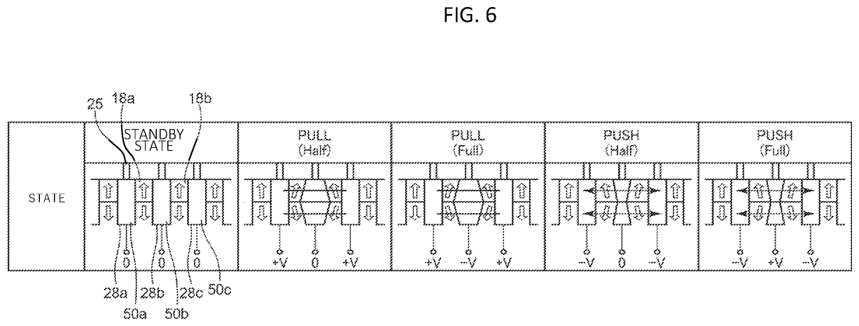

Next, an example of states of the pressure chamber 50 configured as described above will be described with reference to FIG. 6. In FIG. 6, the certain ones of the plurality of pressure chambers are labeled with indexed reference symbols 50a, 50b, and 50c, respectively, and the corresponding electrodes 28a, 28b, and 28c and driving elements 18a and 18b are also shown in the drawing. FIG. 6 mainly illustrates states of the pressure chamber 50b for the purpose of explanation of one embodiment. The pressure chamber 50b changes its state among a standby state, a PULL (Half) state, a PULL (FULL) state, a PUSH (Half) state, and a PUSH (Full) state as further described below.

In the standby state, the pressure chamber 50b is in a default state. As shown in FIG. 6, the head driver 100 makes the potential of the electrode 28b formed in the pressure chamber 50b ground potential GND. The head driver 100 also makes the potentials of the electrodes 28a and 28c formed in the pressure chambers 50a and 50c adjacent to the pressure chamber 50b ground potential GND. In this state, neither the driving element 18a sandwiched between the pressure chambers 50a and 50b nor the driving element 18b sandwiched between the pressure chambers 50b and 50c causes any distortion.

PULL (Half) is a state in which the pressure chamber 50b is expanded. As shown in FIG. 6, the head driver 100 applies a negative voltage −V to the electrode 28b of the pressure chamber 50b and applies a voltage +V to the electrodes 28a and 28c of the neighboring pressure chambers 50a and 50c. In this state, an electric field of the applied voltage V acts on each of the driving elements 18a and 18b in a direction orthogonal to the polarization direction of the driving elements 18a and 18b (may also be collectively referred to as the driving element 18 herein). Due to this electric field, each of the driving elements 18a and 18b deforms outward so as to expand the volume of the pressure chamber 50b. More specifically, in the present embodiment, the driving elements 18a and 18b form chamber walls or side surfaces of each pressure chamber 50b and these deforms outward when the electric field acts thereon so as to pull the walls of the pressure chamber 50b outward, causing the pressure chamber 50b to expand in size.

PULL (Full) is a state in which the pressure chamber 50b expands somewhat more than the PULL (Half) state. As shown in FIG. 6, the head driver 100 applies a negative voltage (−V) to the electrode 28b of the pressure chamber 50b and applies a positive voltage (+V) to the electrodes 28a and 28c of the pressure chambers 50a and 50c. In this state, an electric field having a voltage of 2V acts on each of the driving elements 18a and 18b in a direction orthogonal to the polarization direction of the driving element 18. Due to this electric field, each of the driving elements 18a and 18b deforms further outward so as to further expand the volume of the pressure chamber 50b than the PULL (Half) state.

PUSH (Half) is a state in which the pressure chamber 50b is contracted. As shown in FIG. 6, the head driver 100 applies the ground voltage to the electrode 28b of the pressure chamber 50b and applies voltage −V to the electrodes 28a and 28c of the pressure chambers 50a and 50c. In this state, an electric field of the voltage V acts on each of the driving elements 18a and 18b in a direction opposite to the direction of the electric field of the drive voltage in the PULL (Half) or PULL (Full) state. Due to this electric field, each of the driving elements 18a and 18b deforms inward so as to contract the volume of the pressure chamber 50b. More specifically, the driving elements 18a and 18b forming the side walls of the pressure chamber 50b deform inward when the electric field acts thereon so as to push the walls of the pressure chamber 50b inward, causing the pressure chamber 50b to contract in size.

PUSH (Full) is a state in which the pressure chamber 50b is more contracted than the PUSH (Half) state. As shown in FIG. 6, the head driver 100 applies voltage +V to the electrode 28b of the pressure chamber 50b, and applies voltage −V to the electrodes 28a and 28c of the pressure chambers 50a and 50c. In this state, an electric field having a voltage of 2V acts on each of the driving elements 18a and 18b in a direction opposite to the direction of the electric field of the drive voltage in the PULL (Half) or PULL (Full) state. By this electric field, each of the driving elements 18a and 18b deforms further inward and further contracts the volume of the pressure chamber 50b than the PUSH (Half) state.

When the volume of the pressure chamber 50b is expanded or contracted by the expansion or contraction of the driving elements 18a and 18b, pressure oscillation is generated in the pressure chamber 50b. Due to this pressure oscillation, the pressure in the pressure chamber 50b increases, and the ink droplets are discharged from the nozzle 25 communicating with the pressure chamber 50b.

As described above, the driving elements 18a and 18b separate or partition the pressure chambers 50a, 50b, and 50c from each other and serve as actuators for applying pressure oscillation to the inside of the pressure chamber 50b. These driving elements 18a and 18b constitutes the deformable chamber walls or side surfaces of the chamber 50b. Accordingly, the pressure chamber 50b is expanded or contracted by the operation of the corresponding driving elements 18a and 18b by the head driver 100.

As shown in FIG. 6, each of the pressure chambers 50 shares the driving elements 18 (which acts as partition walls as described above) with another neighboring pressure chamber 50. In this configuration, instead of individually driving the respective pressure chambers 50, the head driver 100 divides every n pressure chambers 50 (where n is an integer equal to or greater than two) into n+1 groups and drives them group-by-group. As one example according to the present embodiment, the head driver 100 divides every two pressure chambers 50 into three sets or groups and performs a so-called three-division drive operation. This three-division drive is merely an example, and a four-division drive, five-division drive, and the like may be employed.

Next, a discharge pulse to be applied to the driving element 18 by the head driver 100 will be described.

The head driver 100 applies to the driving element 18 a discharge pulse for discharging a predetermined amount of ink droplets from the corresponding nozzle 25.

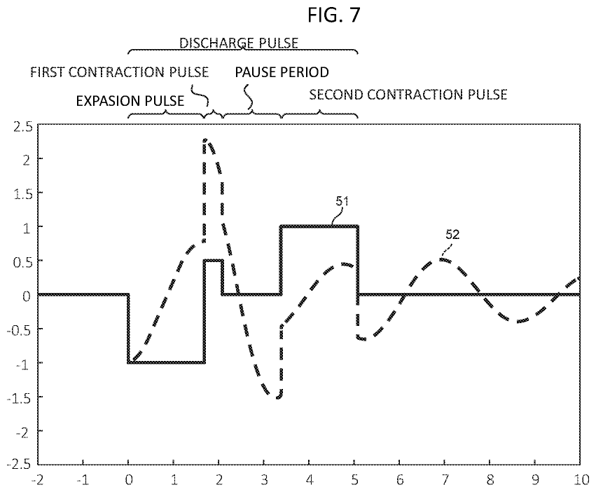

FIG. 7 illustrates an example of discharge pulses. In FIG. 7, the graph line 51 shows a drive waveform (that is, the waveform of the drive signal) that the head driver 100 applies to the driving element 18. The graph line 52 shows pressure oscillations generated in the pressure chamber 50. In FIG. 7, the horizontal axis represents the elapsed time (microseconds). The vertical axis for the graph line 51 indicates the driving voltage (normalized). The vertical axis for the graph line 52 indicates the pressure (normalized) in the pressure chamber 50.

As shown in FIG. 7, the discharge pulse is composed of an expansion pulse, a first contraction pulse, a pause period, and a second contraction pulse.

First, the head driver 100 applies an expansion pulse to the driving element 18 (or more particularly the driving elements 18a and 18b in the example shown in FIG. 6). The expansion pulse is a pulse for applying a predetermined driving voltage for a predetermined time period.

The expansion pulse expands the volume of the pressure chamber 50 formed by the driving element 18 (that is the pressure chamber 50b partitioned by the driving elements 18a and 18b which form the chamber walls in the example shown in FIG. 6; the same goes for the rest of the descriptions of the example shown in FIG. 7). With this expansion pulse, the head driver 100 sets the pressure chamber 50 to the PULL (Full) state for a predetermined period of time from the standby state via the PULL (Half) state. As shown by the graph line 52, in this state, the pressure in the pressure chamber 50 decreases. When the pressure in the pressure chamber 50 decreases, the ink is drawn into the pressure chamber 50 from a common ink chamber or the like.

After applying the expansion pulse, the head driver 100 applies a first contraction pulse to the driving element 18. The first contraction pulse contracts the volume of the pressure chamber 50 formed by the driving element 18. The first contraction pulse is a pulse that applies a voltage of a first crest value (also referred to as a first peak value), that is the absolute value of the drive voltage, (for example, V). With this pulse, the head driver 100 sets the pressure chamber 50 to the PUSH (Half) state for a predetermined period of time from the PULL (full) state through the PULL (Half) state and standby state.

The pressure in the pressure chamber 50 increases while the first contraction pulse is being applied to the driving element 18. When the pressure in the pressure chamber 50 increases, the velocity of the meniscus formed in the nozzle 25 exceeds the threshold at which the ink droplets are discharged. At the timing when the speed of the meniscus exceeds the discharge threshold, the ink droplets are discharged from the nozzle or nozzles 25 of the pressure chamber 50.

The head driver 100 provides a pause period after applying the first contraction pulse. This puts the pressure chamber 50 back to the standby state from the PUSH (Half) state and keeps it in the standby state for a predetermined period of time, that is for the duration of the pause period.

When the pause period has elapsed, the head driver 100 applies a second contraction pulse to the driving element 18. The second contraction pulse contracts the volume of the pressure chamber 50 formed by the driving element 18. The second contraction pulse is a pulse that applies a voltage of a second crest or peak value (e.g., 2V).

The second crest value is greater than the first crest value. For example, the second crest value is two times the first crest value. Since the second crest value is greater than the first crest value, the second contraction pulse causes the volume of the pressure chamber 50 to contract more than the first contraction pulse.

Accordingly, the head driver 100 sets the pressure chamber 50 to the PUSH (Full) state for a predetermined time period passing via the PUSH (Half) state from the standby state. When the predetermined time period has elapsed, the head driver 100 puts the pressure chamber 50 into the standby state passing via the PUSH (Half) state from the PUSH (Full) state.

The head driver 100 applies the discharge pulse to the driving element 18 as described above and causes the ink to be discharged from the pressure chamber 50.

In another embodiment, the head driver 100 may apply a discharge pulse that does not include the first contraction pulse. For example, when the volume of ink droplets to be discharged is larger than a predetermined threshold value, the head driver 100 applies the discharge pulse without the first contraction pulse. When the volume of the ink droplets to be discharged is equal to or less than a predetermined threshold value, the head driver 100 applies the discharge pulse including the first contraction pulse as illustrated in FIG. 7.

The processor 101 may control the circulation device 20 and the like to control the pressure in the pressure chamber 50. For example, when the head driver 100 applies the discharge pulse as illustrated in FIG. 7, the processor 101 may reduce the pressure in the pressure chamber 50. As a result, the meniscus is formed in the back of the nozzle 25, and the speed at which the meniscus is directed toward the outside is increased.

The inkjet head 10 configured as described above applies the contraction pulse between the expansion pulse and the pause period. The inkjet head 10 increases the pressure in the pressure chamber 50 in response to the contraction pulse and increases the velocity of the meniscus. The inkjet head 10 discharges ink droplets by an increase in the velocity of the meniscus due to the contraction pulse. This allows the inkjet head 10 to discharge ink droplets even when the drive voltage of the expansion pulse is low. Consequently, the inkjet head 10 can lower the driving voltage of the expansion pulse and effectively discharge ink droplets having a small volume.

Furthermore, the inkjet head 10 can increase the discharge speed of the ink droplets by using the contraction pulse even in a case where the ink droplets having a volume dischargeable without using the contraction pulse are to be discharged. As a result, the inkjet head 10 or the inkjet recording apparatus 1 comprising such an inkjet head can improve the printing accuracy.

### Second Embodiment

The inkjet recording apparatus according to the second embodiment is different from that of the first embodiment in that a pressure oscillation in the pressure chamber 50 is suppressed by the first contraction pulse. Except for this difference, the configuration and function of the inkjet recording apparatus according to the second embodiment is the same as that of the inkjet recording apparatus 1 of the first embodiment. The same reference numerals are given to the same configuration elements of the inkjet recording apparatus as those of the apparatus 1 of the first embodiment, and detailed descriptions thereof will be omitted hereinafter.

Hereinafter, a discharge pulse to be applied to the driving element 18 by the head driver 100 according to the second embodiment will be described.

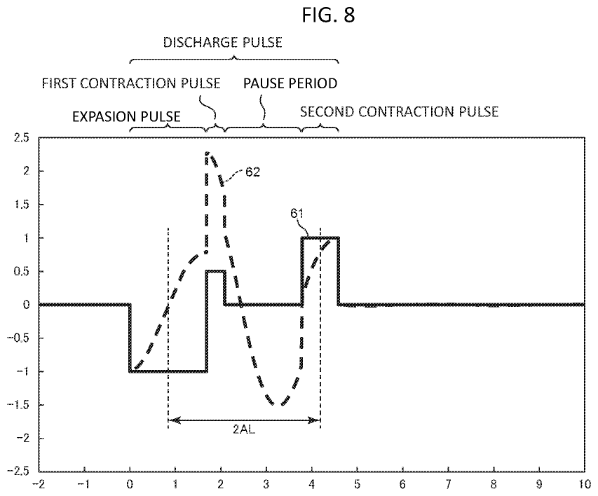

The head driver 100 applies a discharge pulse for discharging a predetermined amount of ink droplets from the nozzle 25 to the driving element 18 as shown in FIG. 8.

FIG. 8 illustrates an example of a discharge pulse applied to the drive element 18 of the inkjet head 10 by the head driver 100 of the inkjet recording apparatus 1 according to the second embodiment. In FIG. 8, the graph line 61 illustrates a drive waveform (that is, the waveform of the drive signal) that the head driver 100 applies to the driving element 18. The graph line 62 shows the pressure oscillations generated in the pressure chamber 50. In FIG. 8, the horizontal axis represents the elapsed time (microseconds). The vertical axis for the graph line 61 indicates the driving voltage (normalized). The vertical axis for the graph line 62 indicates the pressure (normalized) in the pressure chamber 50.

As shown in FIG. 8, the discharge pulse is composed of an expansion pulse, a first contraction pulse, a pause period, and a second contraction pulse. In the second embodiment, the width of the second contraction pulse is different from that of the first embodiment.

First, the head driver 100 applies the expansion pulse to the driving element 18. The expansion pulse is a pulse for applying a predetermined driving voltage for a predetermined time period.

The expansion pulse expands the volume of the pressure chamber 50 when applied to the driving element 18. As shown by the graph line 62, in this state, the pressure in the pressure chamber 50 decreases. When the pressure in the pressure chamber 50 decreases, the ink is drawn into the pressure chamber 50 from a common ink chamber or the like.

After applying the expansion pulse, the head driver 100 applies a first contraction pulse to the driving element 18. The first contraction pulse contracts the volume of the pressure chamber 50 when applied to the driving element 18. The first contraction pulse is a pulse that applies a voltage of the first crest value (or first peak value).

The pressure in the pressure chamber 50 increases while the first contraction pulse is being applied to the driving element 18. When the pressure in the pressure chamber 50 increases, the velocity of the meniscus formed in the nozzle 25 exceeds a threshold value at which the ink droplets are discharged. When the velocity of the meniscus exceeds the discharge threshold value, the ink droplets are discharged from the nozzles 25 of the pressure chamber 50.

The head driver 100 provides a pause period after applying the first contraction pulse. The head driver 100 releases (relaxes) the pressure chamber 50 back to the standby state during the pause period.

When the pause period has elapsed, the head driver 100 applies a second contraction pulse to the driving element 18. The second contraction pulse contracts the volume of the pressure chamber 50 when applied to the driving element 18. The second contraction pulse is a pulse that applies a voltage of the second crest value (or a second peak value).

The second contraction pulse is a pulse for cancelling the pressure oscillation (that is, a residual vibration) generated after the ink droplets are discharged. For example, the second contraction pulse has a pulse width sufficient for cancelling out the residual vibration. The residual vibration in the pressure chamber 50 is thus canceled so that the next discharge is not affected by the oscillations.

The head driver 100 according to the second embodiment applies the discharge pulse to the driving element 18 as described above and causes the ink to be discharged from the pressure chamber 50.

In the example shown in FIG. 8, the width of the expansion pulse is approximately one (1) AL (acoustic length). Here, an acoustic length (AL) is one-half of the natural oscillation cycle of the pressure in pressure chamber 50. Here, the time from the center (midpoint) of the expansion pulse to the center (midpoint) of the second contraction pulse is about two (2) AL.

Next, the relationship between the width of the first contraction pulse and the widths of the pause period and second contraction pulse will be further described.

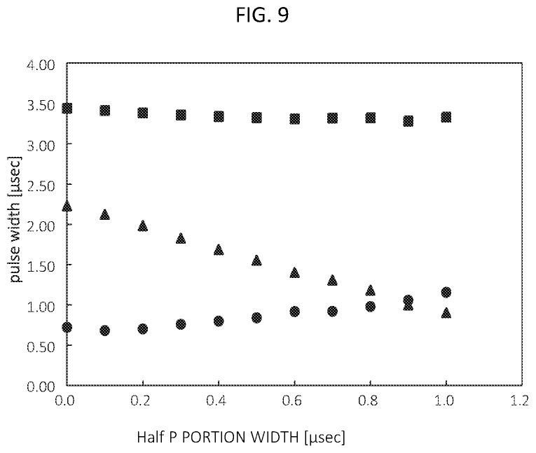

FIG. 9 is a graph showing the width of the pause period and the width of the second contraction pulse such that the residual vibration is minimized. More specifically, FIG. 9 shows the widths of the pause period and second contraction pulse such that the residual vibration is minimized at each width of the first contraction pulse.

The example illustrated in FIG. 9 shows a case where AL=1.7 μsec (L=0.71 μH, C=0.41 μF, and R=0.21Ω) is simulated.

In FIG. 9, the horizontal axis represents the width (psec) of the first contraction pulse. The vertical axis indicates the width of the pause period, the width of the second contraction pulse, and the width from the center of the expansion pulse to the center of the second contraction pulse.

In FIG. 9, “●” symbols indicate the width of the second contraction pulse; “▴” symbols indicate the width of the pause period; and “▪” symbols indicate the width from the center of the expansion pulse to the center of the second contraction pulse.

As described above, the width (▪) from the center of the expansion pulse to the center of the second contraction pulse is about 2 AL (3.4 μsec).

When the width of the first contraction pulse is 0.9 μsec (about 0.5 AL) or less, the width (▴) of the pause period is larger than the width of the second contraction pulse (●). In this case, the width (●) of the second contraction pulse is less than 1.0 μsec (about 0.6 AL).

The inkjet head 10 configured as described above can suppress the residual vibration due to the second contraction pulse. As a result, the inkjet head 10 can prevent or mitigate the influence of the residual vibration from occurring in the subsequent discharge of ink droplets. Therefore, the inkjet recording apparatus 1 comprising such an inkjet head 10 can improve the printing accuracy. For example, the inkjet recording apparatus 1 can improve the linearity of dots formed by ink droplets discharged from a plurality of nozzles 25 or a plurality of ink channels.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention and are included in the invention described in the appended claims and the equivalents thereof.

What is claimed:

1. An inkjet head, comprising:
an actuator configured to expand and contract a pressure chamber; and
a controller configured to apply a discharge pulse to the actuator, the discharge pulse comprising an expansion pulse for expanding the pressure chamber, a first contraction pulse with a first peak value for contracting the pressure chamber, a pause period, and a second contraction pulse with a second peak value that is higher than the first peak value for further contracting the pressure chamber.

2. The inkjet head according to claim 1, wherein the second peak value is at least twice the first peak value.

3. The inkjet head according to claim 1, wherein a width of the expansion pulse is one acoustic length (AL), and a width from a midpoint of the expansion pulse to a midpoint of the second contraction pulse is two acoustic lengths (AL).

4. The inkjet head according to claim 3, wherein the width of the first contraction pulse is less than or equal to one-half the acoustic length (AL).

5. The inkjet head according to claim 3, wherein the width of the expansion pulse is one-half of a natural vibration cycle of the pressure chamber.

6. The inkjet head according to claim 1, wherein the controller is further configured to apply the first contraction pulse between the expansion pulse and the pause period.

7. The inkjet head according to claim 1, wherein the second contraction pulse has a width sufficient for substantially cancelling a pressure oscillation generated in the pressure chamber by a discharge of a liquid from the pressure chamber.

8. The inkjet head according to claim 1, wherein the controller is configured to control the pressure in the pressure chamber while applying the discharge pulse to the actuator.

9. The inkjet head according to claim 1, wherein
the actuator comprises a plurality of driving elements, and
the driving elements are side walls of pressure chambers.

10. The inkjet head according to claim 9, wherein the plurality of driving elements divide a plurality of pressure chambers.

11. The inkjet head according to claim 10, wherein the controller is configured to apply the discharge pulse to n+1 groups of the pressure chambers where every n pressure chambers are grouped and where n is an integer equal to or greater than two.

12. An inkjet recording apparatus, comprising:
a support configured to support a medium onto which a liquid droplet is discharged; and
an inkjet head comprising:
an actuator configured to expand and contract a pressure chamber; and
a controller configured to apply a discharge pulse to the actuator, the discharge pulse comprising an expansion pulse for expanding the pressure chamber, a first contraction pulse with a first peak value for contracting the pressure chamber, a pause period, and a second contraction pulse with a second peak value that is higher than the first peak value for further contracting the pressure chamber.

13. The inkjet recording apparatus according to claim 12, wherein the second peak value is at least twice the first peak value.

14. The inkjet recording apparatus according to claim 12, wherein a width of the expansion pulse is one acoustic length (AL), and a width from a midpoint of the expansion pulse to a midpoint of the second contraction pulse is two acoustic lengths (AL).

15. The inkjet recording apparatus according to claim 14, wherein the width of the first contraction pulse is less than or equal to one-half the acoustic length (AL).

16. The inkjet recording apparatus according to claim 14, wherein the width of the expansion pulse is one-half of a natural vibration cycle of the pressure chamber.

17. The inkjet recording apparatus according to claim 12, wherein the controller of the inkjet head is further configured to apply the first contraction pulse between the expansion pulse and the pause period.

18. An inkjet head, comprising:
a plurality of actuators configured to expand and contract a plurality of pressure chambers filled with a liquid; and
a controller configured to apply a discharge pulse to the plurality of actuators, the discharge pulse comprising an expansion pulse for expanding the pressure chambers, a pause period, and a first contraction pulse for expanding the pressure chambers.

19. The inkjet head according to claim 18, wherein
each actuator comprises a first driving element and a second driving element, and
the first and second driving elements form side walls of a pressure chamber.

20. The inkjet head according to claim 19, wherein the controller is further configured to apply the first contraction pulse between the expansion pulse and the pause period.
